(19) United States
(12) Patent Application Publication
(10) Pub. No.: US 2009/0320989 A1
(43) Pub. Date: Dec. 31, 2009

(54) METHOD OF AND APPARATUS FOR WINDING A LENGTHY RUBBER MATERIAL

(75) Inventors: Tetsuo Tatara, Osaka (JP); Tomoyuki Takatsuka, Osaka (JP); Hirokatsu Mizukusa, Osaka (JP); Osamu Fujiki, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO TIRE & RUBBER CO., LTD., Osaka-shi, Osaka (JP)

(21) Appl. No.: 12/303,286

(22) PCT Filed: Jun. 5, 2006
(86) PCT No.: PCT/JP2006/311207

§ 371 Date: Apr. 3, 2009

(51) Int. Cl. B65H 81/04; B29C 53/64

(52) U.S. Cl. 156/149; 156/425

(57) ABSTRACT

In the case where a lengthy rubber material (R) is wound on a winding roll (30) mounted on a moving cart (20), the invention prevents excessive bonding of the rubber material between respective layers and is capable of pulling out and supplying the rubber material as wound without a problem, and the lengthy rubber material (R) continuously extruded in a lengthy manner from a rubber extruder to be fed to a winding position is wound to be made spiral with alternately reverse inclination every layer while being caused by a traverse guide to traverse to the winding roll (30) mounted on the cart (20) in accordance with rotation of the roll.

### TECHNICAL FIELD

The present invention relates to a method of and an apparatus for winding a lengthy rubber material, which is supplied mainly to an extruder of a rubber strip for building of a tire, on a winding roll on a cart.

### BACKGROUND ART

In recent years, from the viewpoint of the requirement for accuracy of building on a tire configuration and the requirement for improvement in tire balance, uniformity, etc., in, for example, building of a tire, a ribbon-shaped rubber strip having a predetermined cross sectional shape is wound round an outer periphery of a tire building drum in a layered manner, while being extruded and built on the building drum, which is rotationally driven, by an extruder to form a rubber member of a tire constituent material having a predetermined profile as shown in JP-A-9-29858 and JP-A-2002-178415.

By the way, it is necessary to continuously supply a rubber material to an extruder of the rubber strip used in a tire building process since the rubber strip is continuously extruded and built according to the operation of a tire building machine.

Conventionally, a rubber material is supplied to the extruder such that a rubber material of raw rubber extruded by the extruder of rubber material in a material preparation process to be made lengthy and formed into a relatively thick band is folded randomly and accommodated in a conveyance container, such as basket, box, or the like, put on a moving cart and conveyed to a portion of the extruder of rubber strip to be continuously supplied from a supply port of the extruder while the rubber material is pulled out of the container.

Since the lengthy rubber material extruded in the material preparation process is folded randomly and accommodated in the conveyance container to include voids, an amount of storage is small although being bulky. Besides, the weight of the whole rubber material in the container acts on a rubber material in a lower layer and is increased as it goes toward lower layers. In particular, the larger an amount of storage, the larger the weight. Consequently, overlapping portions of the rubber material as accommodated undergo excessive deformation occasionally and contacted portions of the rubber material as accommodated bond firmly and do not peel off readily to cause a fear that elongation and cut are generated due to the pulling action, so that it is not possible in some cases to smoothly perform the work of pulling and supplying the rubber material.

Therefore, the lengthy rubber material in the conveyance container cannot be increased in amount of storage, so that it is necessary to relatively frequently perform conveyance of the container to a tire building process and the work of exchanging and setting the container in the pulling-out and supplying portion, which results in hindering an improvement in working efficiency.

Hereupon, the inventors of the present application have thought of winding the lengthy rubber material on a winding roll provided on a moving cart in order to increase the same in amount of conveyance each time.

In this case, when winding on the winding roll comprises simply overlapping and winding like winding of an ordinary band-shaped rubber material or the like, rubber materials between respective layers as wound contact each other in a wide range and continuously circumferentially and the contacted portions bond together and will not peel off readily, so that it is not possible to smoothly perform pulling-out and supplying. On the other hand, winding with separation sheets interposed between the respective layers needs a specific apparatus therefor to make the apparatus itself high in cost and is not appropriate for supplying of a rubber material for extrusion and building of a rubber strip used in a tire building process.

### Patent Document 1: JP-A-9-29858

### Patent Document 2: JP-A-2002-178415

### DISCLOSURE OF THE INVENTION

### Problems that the Invention is to Solve

The invention has been thought of in view of the problem and has its object to perform winding in a manner to prevent excessive bonding of rubber materials, in particular, between respective layers and to pull out and supply the wound rubber material without causing any problem, in the case where a lengthy rubber material being supplied to an extruder or the like is wound on a winding roll mounted on a moving cart so as to efficiently convey the lengthy rubber material, and the invention provides a method of winding a lengthy rubber material and an apparatus therefor.

### Means for Solving the Problems

In a method of winding a lengthy rubber material, according to the invention, a lengthy rubber material continuously extruded in a lengthy manner from a rubber extruder to be fed to a winding position is wound to be made spiral with alternately reverse inclination every layer while being caused by a traverse guide to traverse a winding roll mounted on a moving cart in accordance with rotation of the roll.

Thereby, the weight of the lengthy rubber material as wound acts on an inner layer side above the winding roll but acts little on the inner layer side below the roll, so that the weight acting on the inner layer side is decreased as a whole, thus being capable of winding the lengthy rubber material without generation of excessive deformation or bonding and being capable of correspondingly increasing a quantity as wound.

Besides, since the lengthy rubber material wound on the winding roll is made spiral with alternately reverse inclination every layer and the wound rubber portions of the respective layers contact only on mutually intersecting portions thereof, a contact area between the respective layers decreases, the weight acting on the inner layer side is small, and intense boding is not generated, so that even if the contacting portions bond, it is possible to make peeling relatively readily. Therefore, it is possible to increase the quantity of the lengthy rubber material as wound and to smoothly and continuously perform pulling-out and supplying to the extruder or the like.

In the method of winding a lengthy rubber material, preferably, the lengthy rubber material has a cross sectional shape being a little thick and flat such as rectangular, elliptical, or the like and is wound while being caused to traverse at a larger pitch than the width dimension of the rubber material. A spacing is retained every one circumference wound rubber portion, so that a contact area between respective layers is decreased, thus being capable of preventing the generation of excessive bonding.

Preferably, the rotating speed of the winding roll and that moving speed in an axial direction, at which the lengthy rubber material is caused to traverse, are controlled according to winding of the lengthy rubber material to make the quantity of the rubber material as wound uniform over a total length in a roll axial direction.

Also, the invention has a feature in an apparatus for winding a lengthy rubber material in order to carry out the winding method described above, the apparatus comprising a conveyor device that feeds a lengthy rubber material continuously extruded from a rubber extruder, a traverse guide supported in a position, in which the lengthy rubber material is forwarded from the conveyor device, to be made able to reciprocatively move in a width direction intersecting the forwarding direction and moving while guiding the lengthy rubber material to enable forwarding the same, a moving cart mounted in a predetermined installation below the traverse guide so that it can be pulled out, a winding roll that is supported on the cart and can be rotationally driven so that an axis thereof is made in parallel to a moving direction of the traverse guide in a state, in which the cart is mounted, and wherein the traverse guide repeats reciprocating movements in an axial direction of the roll according to rotation of the winding roll to thereby wind the lengthy rubber material while causing the same to traverse in the axial direction of the winding roll.

Thereby, it is possible to wind the lengthy rubber material on the winding roll such that respective layers thereof are made spiral with alternately reverse inclination, thus being capable of readily carrying out the winding method of the invention.

In the winding apparatus, two forward and rear traverse guides are provided forwardly of a tip end of the feed conveyor device, corresponding installations for the carts are set below the both traverse guides, and winding rolls provided on the carts mounted in the both installations alternately wind the lengthy rubber material. Thereby, when winding of the lengthy rubber material on the winding roll on the cart of one of the installations is completed, winding of the lengthy rubber material is switched to the cart of the other of the installations, thus being capable of conveying the one of the carts to a position, in which the lengthy rubber material is used, or making an exchange with a fresh cart provided with an empty winding roll to set the same while continuing winding on the winding roll on the cart.

In the winding apparatus, the traverse guide comprises a pair of forward and rear rollers arranged widthwise to a direction, in which the lengthy rubber material is forwarded, and a pair of left and right rollers arranged longitudinally at least above or below the rolls, the traverse guide being provided to perform guiding fore and aft and left and right. Thereby, it is possible to guide and traverse the lengthy rubber material so as not to generate a twist or the like, thus being capable of surely winding such that respective layers are made spiral in a predetermined manner.

In the winding apparatus, a shell portion of the winding roll on the moving cart is formed by a perforate plate or a meshy body to be drum-shaped, and the drum-shaped shell portion is partially formed with an opening, which enables a wind beginning end of the lengthy rubber material to be inserted thereinto and latched thereon. Thereby, a wind beginning end of the lengthy rubber material is inserted into and latched on the opening to thereby be capable of winding surely and preventing the rubber material from coming into close contact with the roll surface.

In the winding apparatus, the winding roll is provided at one end thereof with an engaging connection, which engages with a rotation transmitting portion set on a part of a predetermined installation to be capable of transmitting power when the moving cart is mounted on the installation.

In the winding apparatus, the feed conveyor device is provided to enable a rear end side thereof in a feed direction to make a telescopic adjustment in a longitudinal direction.

### Effect of the Invention

With the winding method and the winding apparatus, according to the invention, by winding a lengthy rubber material continuously extruded from a rubber extruder, on a winding roll provided on a moving cart so that respective layers thereof are made spiral with alternately reverse inclination, it is possible to increase the quantity of the lengthy rubber material as wound, thus being capable of an increase in conveyance efficiency and to prevent excessive bonding of the rubber material between respective layers to smoothly and continuously perform pulling-out and supplying to the extruder or the like.

### BEST MODE FOR CARRYING OUT THE INVENTION

A mode for carrying out the invention will be described below on the basis of an embodiment shown in the drawings.

FIG. 1 is a schematic, plan view showing the outline of the production equipment of a lengthy rubber material, which includes a winding apparatus of the invention and FIG. 2 is a schematic, side view showing the equipment. FIG. 3 is a schematic, plan view showing a drying apparatus of the equipment, FIGS. 4 and 5 are cross sectional views showing a part of the drying apparatus, FIG. 6 is a schematic, plan view showing a conveyor device of the equipment, FIG. 7 is a schematic, side view showing the conveyor device, and FIG. 8 is a schematic, cross sectional view illustrating the telescopic function of the conveyor device. FIG. 9 is a plan view showing, in enlarged scale, a main portion of a winding apparatus. FIGS. 10 and 11 are a side view and a front view in enlarged scale. FIG. 12 is a plan view showing a traverse guide and FIGS. 13 and 14, respectively, are cross sectional views showing the traverse guide. FIG. 15 is a plan view showing a moving cart provided with a winding roll, FIG. 16 is a cross sectional view showing the moving cart, and FIG. 17 is a view illustrating, in enlarged scale, a wound state.

In FIG. 1 and FIG. 2, the reference numeral 1 denotes an extruder that continuously extrudes a rubber material in a predetermined cross sectional shape and in a lengthy manner, and a single, lengthy rubber material R is normally extruded from a die 2 at a tip end of the extruder. While the cross sectional shape of the lengthy rubber material R may be any one of circular, square shapes, or the like, the cross section is preferably a little thick and flat such as rectangular, elliptical, or the like from the viewpoint of stability at the time of conveyance by conveyance means described later and winding.

The reference numeral 3 denotes a processing vessel mounted subsequently to the die 2 to process a release agent liquid or the like and provided to immerse the lengthy rubber material R, which is extruded in parallel, in the release agent liquid or the like in the processing vessel 3 to forward the same in a state of surface preparation.

The reference numeral 4 denotes a drying apparatus mounted subsequently to the processing vessel 3 and provided to air-dry or dry the lengthy rubber material R, to which the release agent liquid or the like adheres, with air blasting by a blower as the same is conveyed, though a detailed explanation is omitted. As shown in FIGS. 3 to 5, the drying apparatus 4 comprises conveyance means 5 provided on an upper opening of a box-shaped body 41, which is rectangular in a feed direction (longitudinal direction) from the processing vessel 3, to support and convey the lengthy rubber material R in a suspended state.

The conveyance means 5 comprises a turning member 53, such as chain or the like, stretched round sprockets 52, 52 on vertical shafts 51, 51 arranged forward and rearward at an interval centrally of the upper opening of the body 41 in a width direction and provided to reciprocate in a longitudinal direction, that is, lengthwise of the body 41 on a plane along the upper opening of the body 41. Further, a multiplicity of latch bars 55 extending outward in a direction perpendicular to a turning direction are provided at predetermined intervals in a longitudinal direction of the turning member 53 and reciprocative turning of the turning member 53 causes the respective latch bars 55 to reciprocatively turn through the rotating portions at both longitudinal ends forward in the feed direction on one side half portion 4a widthwise of the body 41 and rearward reversely to the above in the feed direction on the other side half portion 4b. The lengthy rubber material R is supported in a substantially U-shaped, suspended state and conveyed by causing a feed drive roller 42 arranged above the rotating portion on a side of the body 41 toward the processing vessel 3 to feed and suspend the lengthy rubber material R and latching the lengthy rubber material R on the respective rotating latch bars 55 at predetermined intervals in the longitudinal direction. Thereby, the function as an accumulator is accomplished.

The respective latch bars 55, respectively, are provided at both ends thereof with rolling rollers 56, 56 and the rollers 56, 56 are rollingly born on guide rails 43, 43 provided in parallel inside and outside the upper opening of the body 41 whereby they are held in a horizontal state to be able to turn.

The reference numeral 6 denotes a feed conveyor device arranged to project forward in the feed direction from a position above a rear portion of the half portion 4b disposed on a rear conveyance side of the drying apparatus 4 in the feed direction and provided to pull the lengthy rubber material R, which is latched on the latch bars 55 of the conveyance means 5 to be conveyed, upward on a side of the rear portion of the half portion 4b, to send the same forward with a tip end forward.

As shown in FIGS. 6 to 8, the conveyor device 6 comprises a belt conveyor composed of an endless belt, of which a conveyor body 60 is stretched between rollers 61, 62 at both longitudinal ends, and the roller 61 at the forward end is rotationally driven by a drive motor 63 such as servomotor or the like whereby the upper running portion is turned forward in the feed direction. In the case shown in the figure, a rear end portion of the conveyor body 60 is bent downward and inclined so as to smoothly receive the lengthy rubber material R from the conveyance means 5. The reference numerals 64, 65 denote rollers that bend the conveyor body 60. The reference numeral 66 denotes a guide member that positions the lengthy rubber material R pulled onto the conveyor body 60 from the conveyance means 5.

The conveyor device 6 is provided to be capable of telescopic adjustment on a rear side in the feed direction. As means therefor, the conveyor body 60 on a lower running portion thereof is stretched between the rollers 61, 62 at both longitudinal ends through a Z-shaped shuttle portion with an intermediate roller 67 for shuttling and a roller 68 for adjustment of movement therebetween, and the roller 68 for adjustment of movement and the roller 62 at the rear end are supported in a state of retaining a predetermined spacing to be capable of positional adjustment in a longitudinal direction, the conveyor body being constructed so that positional adjustment of the both rollers 68, 62 enables a total length of the conveyor device 6 to telescopically adjust on a rear portion side between a position of solid lines and a position of two-dot chain lines in FIG. 8. The reference numeral 69 denotes drive means for telescopic adjustment.

Thereby, for example, when the conveying action of the conveyance means 5, that is, turning of the turning member 53 is stopped as the operation of the extruder 1 stops, the lengthy rubber material R latched on the latch bars 55 can be continuously pulled out and fed by moving a rear end position of the conveyor device 6 forward. Also, contrary to the above, when feed of the conveyor device 6 is temporarily stopped due to exchange of a winding roll on a cart described later, the rear end position of the conveyor device 6 is moved rearward whereby it is possible to continuously effect extrusion of the lengthy rubber material R from the extruder 1 and conveyance by the conveyance means 5.

Two installations P1, P2 for moving carts 20, 20, respectively, provided with winding rolls described later are set below a feed position on a tip end side of the feed conveyor device 6 to be aligned fore and aft in the feed direction.

As shown in FIGS. 9 to 11, traverse guides 10a, 10b, by which the lengthy rubber material R fed and suspended from the tip end of the conveyor device 6 is caused to axially traverse winding rolls described later at the time of winding, are provided in positions a little above the installations P1, P2 to be able to reciprocate in a width direction perpendicular to the feed direction of the lengthy rubber material R.

As shown, in enlarged scale, in FIGS. 12 to 14, the traverse guides 10a, 10b in the figures comprise a pair of forward and rear rollers 12, 12 arranged in parallel to the width direction inside a square support frame 11 opened up and down and respective pairs of left and right rollers 13, 13, and 14, 14 arranged in parallel in a longitudinal direction and above and below or at least above or below the rollers 12, 12, for example, both above and below the rollers, and intervals between the respective pairs of rollers are appropriately set according to the cross sectional shape of the lengthy rubber material R whereby the lengthy rubber material R passing through the intervals can be suspended without generation of twist or the like. Normally, the pair of forward and rear rollers 12, 12 and the respective pairs of left and right rollers 13, 13, and 14, 14, respectively, are provided to afford interval adjustment.

As means for moving the traverse guides 10a, 10b in the width direction, moving means 15, such as uniaxial actuator or the like, driven by a servomotor is provided along transverse frames 17 supported in the width direction, and the respective support frames 11 of the traverse guides 10a, 10b are mounted and fixed to a moving body 16, which is reciprocatively moved by the operation of the moving means 15 in the width direction, and provided to reciprocatively move together with the moving body 16. The transverse frames 17 are supported on body frames 18 laterally provided upright.

In the case shown in the figure, guide bar members 7a, 7b, respectively, for restriction of suspended positions of the lengthy rubber materials R as fed are provided a little below a feed position from the feed conveyor device 6 and in positions above the traverse guides 10a, 10b, which correspond to the installations P1, P2 whereby the case where the lengthy rubber material R is put on and suspended from one 7a of the bar members to pass through one 10a of the traverse guides therebelow, and the case where the lengthy rubber material R is put on and suspended from one 7b of the bar members to pass through one 10b of the traverse guides therebelow, can be selected according to winding on winding rolls described later.

In addition, the guide bar members 7a, 7b are not necessarily needed but may be omitted and the lengthy rubber material R fed from the conveyor device 6 may be passed directly through one of the traverse guides 10a, 10b.

Also, an auxiliary feed conveyor (not shown) for adjustment of a fed position of the lengthy rubber material R at need can be provided at an end on a feed side of the feed conveyor device 6 to be movable in a longitudinal direction. In this case, it is also possible to omit the guide bar members 7a, 7b.

Winding rolls 30 having flanges 31, 31 at both axial ends thereof are supported on the carts 20 mounted drawably on the two installations P1, P2 to be enabled to be rotationally driven as shown in FIGS. 15 and 16. In a state, in which the carts 20 are mounted on the installations P1, P2 (chain lines in FIGS. 9 to 11), spindles 32 of the winding rolls 30 projecting from the flanges 31, 31 at both axial ends thereof are pivotally supported by bearings 22 provided on support frames 21 on the carts 20 so that an axes of the winding rolls 30 are made in parallel to a moving direction of the traverse guides 10.

Engaging connections 33 for engagement with rotation transmitting portions 23 provided on the body frames 18 along the installations P1, P2 to be capable of transmitting power thereto are provided at ends of the spindles 32 of the winding rolls 30 projecting from the support frames 21.

Specifically, rotation transmitting shafts 26 connected through rotation transmitting mechanisms 25, such as chain, etc., to drive means 24 such as motor or the like are provided on the body frames 18 to be positioned corresponding axially to the spindles 32 on the installations P1, P2, and the rotation transmitting portions 23 comprising plate bodies having a plurality of engagement holes 23a are provided at opposite ends of the rotation transmitting shafts 26 to the spindles 32 of the winding rolls 30. On the other hand, the engaging connections 33 comprising plate bodies including projections 33a fitted into and engaged by the engagement holes 23a are provided at ends of the spindles 32 of the winding rolls 30 on the carts 20. Thereby, the cart 20 is laterally pushed into and mounted in the installation P1 or P2 whereby the projection 33a of the engaging connection 33 is fitted into and engaged by the engagement hole 23a of the rotation transmitting portion 23, so that rotation of the rotation transmitting shaft 26 can be transmitted to the winding roll 30.

Rotation of the winding roll 30 is controlled so that the speed of a surface portion caused by winding is always maintained constant according to the feed speed of the lengthy rubber material R and specially controlled so that as the wound diameter of the lengthy rubber material R gradually increases, the roll rotating speed gradually decreases and set and controlled so as to be capable of winding with little tension on the lengthy rubber material R.

Also, the traverse guides 10 are controlled in reciprocating movements so as to axially traverse the winding roll 30 at a predetermined pitch in an axial direction and in opposite directions every layer in accordance with winding of the lengthy rubber material R by rotation of the winding roll 30. In particular, as shown, in enlarged scale, in FIG. 17, control is exercised so that traverse movements are made at a larger pitch p than the width dimension w of the lengthy rubber material R being wound to retain a spacing S every wound rubber portion Ra of each circumference. Thereby, it is possible to wind the lengthy rubber material R on the winding roll 30 such that respective layers thereof are made spiral with alternately reverse inclination and a spacing S is retained every wound rubber portion Ra, thus being capable of decreasing a contact area every layer.

In addition, it is desirable to control movements of the traverse guides 10 in a manner to gradually change the moving speed and switch a direction of movement so that smooth and curvilinear turning over circumferential wound portions is made on turned portions of the lengthy rubber material R at both axial ends of the winding roll 30. That is, the moving speed is gradually decreased before turning, turning is made through circumferential wound portions by stoppage of movements, and the speed is gradually increased after turning to reach a predetermined moving speed. Thereby, the rubber material R is not folded at both axial ends of the winding roll 30 but turned smoothly and curvilinearly, thus being capable of winding every layer spirally with alternately reverse inclination.

A shell portion 35 of the winding roll 30 is formed by a perforate plate or a meshy body as shown in the figure to be drum-shaped, the drum-shaped shell portion 35 being partially formed with an opening 36, which enables a wind beginning end Ra of the lengthy rubber material R to be inserted thereinto and latched thereon, whereby the wind beginning end Ra can be readily latched on the shell portion 35 of the roll to be wound.

The winding apparatus according to the embodiment winds the lengthy rubber material R in the following manner.

The lengthy rubber material R extruded from the die 2 of the extruder 1 is caused to pass through the processing vessel 3 of the release agent liquid or the like, then dried and conveyed by the conveyance means 5 of the drying apparatus 4, pulled out of the drying apparatus 4 in the half portion 4b on a rear conveyance side in the feed direction by the feed conveyor device 6 to be fed forward to be continuously forwarded from the tip end of the feed conveyor device 6.

In the case where the lengthy rubber material R being forwarded in the manner described above is to be wound on the winding roll 30 on the moving cart 20 mounted on one of the two installations P1, P2 aligned fore and aft, for example, the installation P1, a tip end of the lengthy rubber material R is passed in a preparation work for the winding through the traverse guide 10a, which corresponds to the installation P1, via the guide bar member 7a above the installation P1, or not via the guide bar member to be inserted into and latched on the opening 36 of the shell portion 35 of the roll 30.

In this manner, while the lengthy rubber material R is continuously forwarded, the winding roll 30 is rotated at a speed corresponding to the forwarding speed and the lengthy rubber material R is wound on the winding roll 30 with little tension thereon. At this time, the traverse guide 10a is reciprocatively moved in a width direction perpendicular to the forwarding direction whereby the lengthy rubber material R is wound on the winding roll 30 spirally with alternately reverse inclination every layer at a predetermined pitch according to rotation of the roll, for example, at a larger pitch p than the width dimension w of the lengthy rubber material R so as to retain a spacing S every wound rubber portion Ra of each circumference (FIG. 17).

When a predetermined quantity wound on the winding roll 30 on the moving cart 20 of the installation P1 is reached, the lengthy rubber material R is cut and rotation of the winding roll 30 and movements of the traverse guide 10a are stopped, that is, winding on the winding roll 30 is stopped. On the other hand, a fresh tip end of the lengthy rubber material R forwarded from the feed conveyor device 6 is caused to pass through the traverse guide 10b, which corresponds to the installation P2, via the guide bar member 7b above the other P2 of the installations, or not via the guide bar member to be inserted into and latched on the opening 36 of the shell portion 35, and the winding roll 30 is rotated in the same manner described above to wind every layer spirally with alternately reverse inclination while the traverse guide 10b is reciprocatively moved in the width direction to make a traverse at a predetermined pitch.

Also, while the lengthy rubber material R is wound in the installation P2, the cart 20 on the installation P1 is pulled out of the installation P1 to be conveyed to a portion of the extruder or the like in a tire building process and a cart 20 provided with an empty winding roll 30 is newly set in the installation P1. In this manner, the lengthy rubber material R can be wound on the winding roll 30 on the cart 20 alternately and continuously in the two installations P1, P2 to be made spiral with alternately reverse inclination every layer.

As described above, the lengthy rubber material R is wound on the winding roll 30 to be made spiral with alternately reverse inclination every layer whereby the weight of the rubber material R acts on an inner layer side above the winding roll 30 but acts little on the inner layer side below the winding roll 30, so that the weight acting on the inner layer side is decreased as a whole, thus being capable of winding the lengthy rubber material R without generation of excessive deformation or bonding and being capable of correspondingly increasing a quantity as wound.

Besides, since the lengthy rubber material R wound on the winding roll 30 is made spiral with alternately reverse inclination every layer and the wound rubber portions Ra of the respective layers contact only on mutually intersecting portions thereof, a contact area between the respective layers decreases and the weight acting on the inner layer side is small, so that even if the contacting portions bond, excessive bonding is not generated, thus being capable of peeling relatively readily.

Therefore, it is possible to increase the quantity of the lengthy rubber material R as wound and to smoothly and continuously perform pulling-out and supplying to the extruder or the like in a tire building process.

Also, in the case where the rubber material is folded randomly and accommodated in the container, it is difficult to quantitatively measure the quantity of the rubber material as used but by winding the rubber material on the winding roll, it becomes readily possible to measure the quantity of the rubber material as used on the bases of the rotational count of the roll or the like.

### INDUSTRIAL APPLICABILITY

The method of and apparatus for winding a lengthy rubber material, according to the invention, can be preferably made use of in winding a lengthy rubber material, which is supplied to an extruder of a rubber strip mainly for tire building, on a winding roll mounted on a moving cart.

### BRIEF DESCRIPTION OF THE DRAWINGS

FIG. 1 is a schematic plan view showing the outline of the production equipment of a lengthy rubber material, which includes a winding apparatus of the invention.

FIG. 2 is a schematic side view showing the equipment.

FIG. 3 is a schematic plan view showing a drying apparatus of the equipment.

FIG. 4 is a cross sectional view showing a part of the drying apparatus.

FIG. 5 is a cross sectional view crossing a part of the drying apparatus.

FIG. 6 is a schematic plan view showing a conveyor device of the equipment.

FIG. 7 is a schematic side view showing the conveyor device.

FIG. 8 is a schematic, cross sectional view illustrating the telescopic function of the conveyor device.

FIG. 9 is a plan view showing, in enlarged scale, a main portion of a winding apparatus.

FIG. 10 is a side view showing, in enlarged scale, the main portion.

FIG. 11 is a plan view showing, in enlarged scale, the main portion.

FIG. 12 is a plan view showing a traverse guide.

FIG. 13 is a front view showing the traverse guide.

FIG. 14 is a cross sectional view showing the traverse guide.

FIG. 15 is a plan view showing a moving cart provided with a winding roll.

FIG. 16 is a cross sectional view showing the moving cart.

FIG. 17 is a view illustrating a state, in which a lengthy rubber material R is wound.

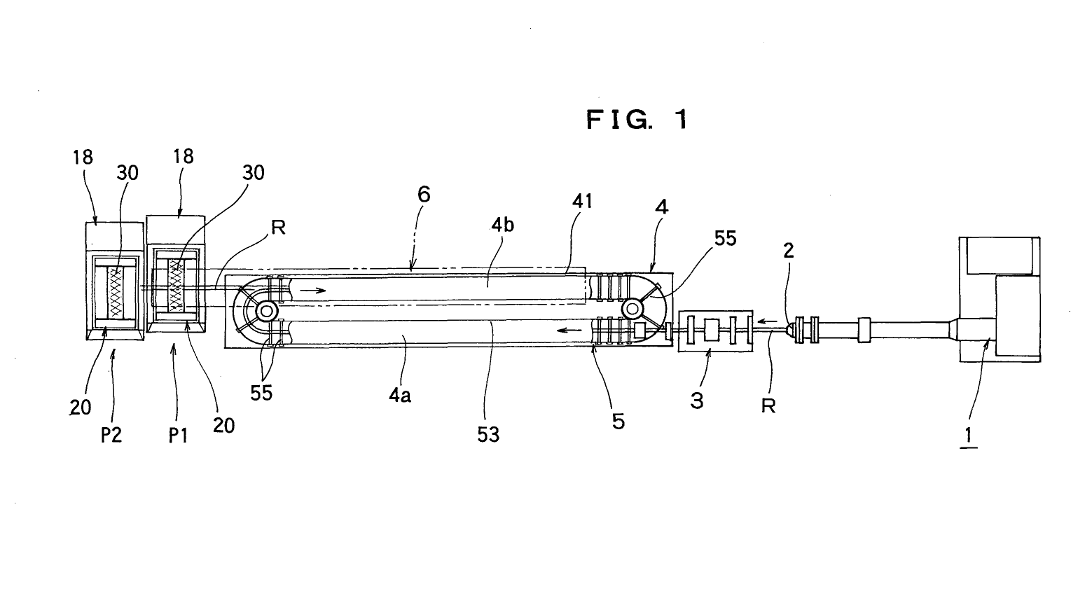

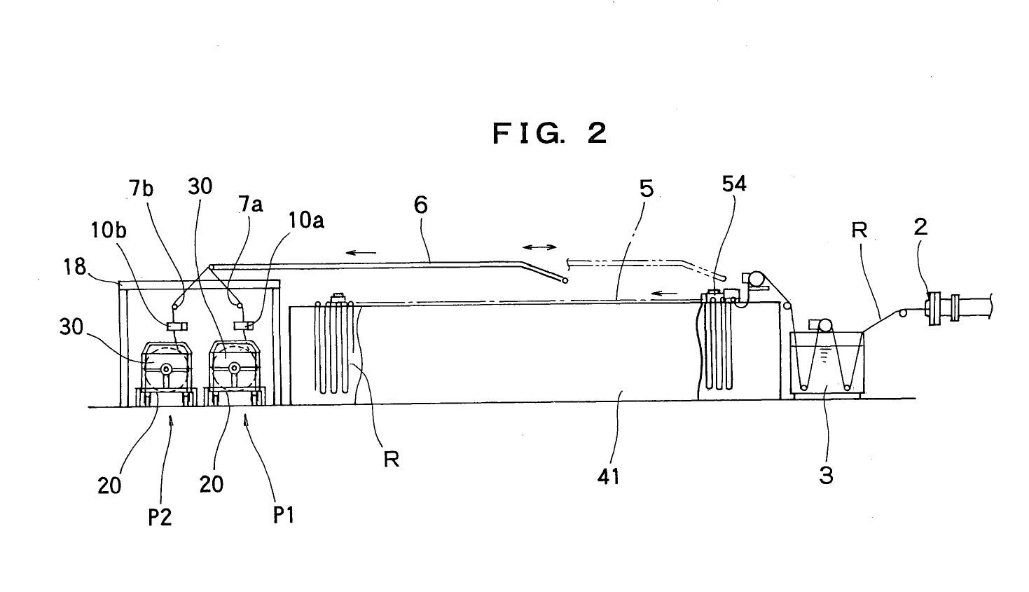

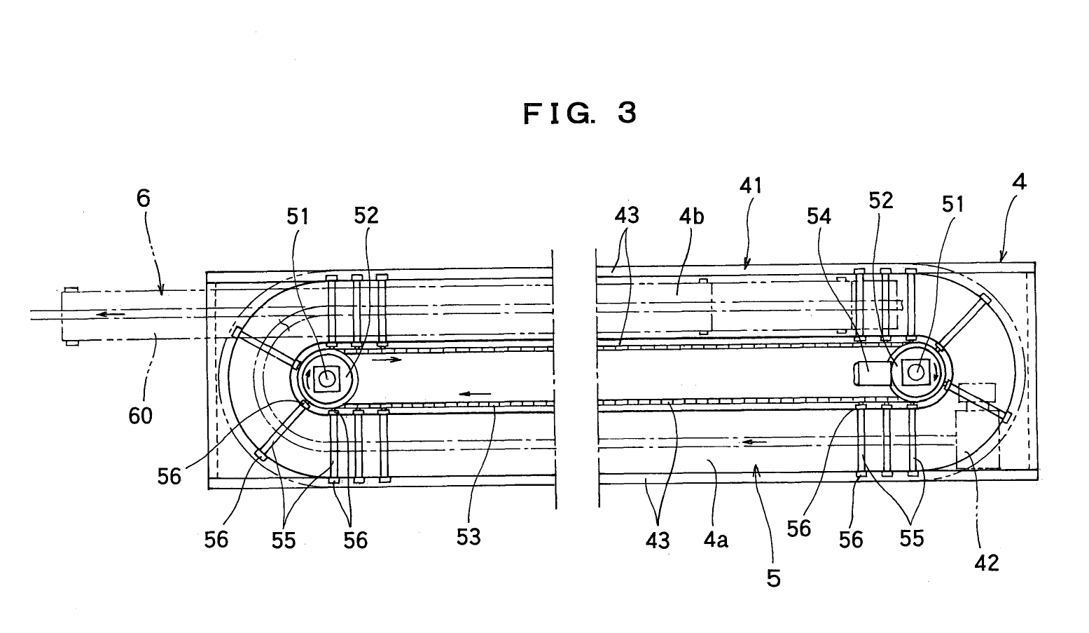

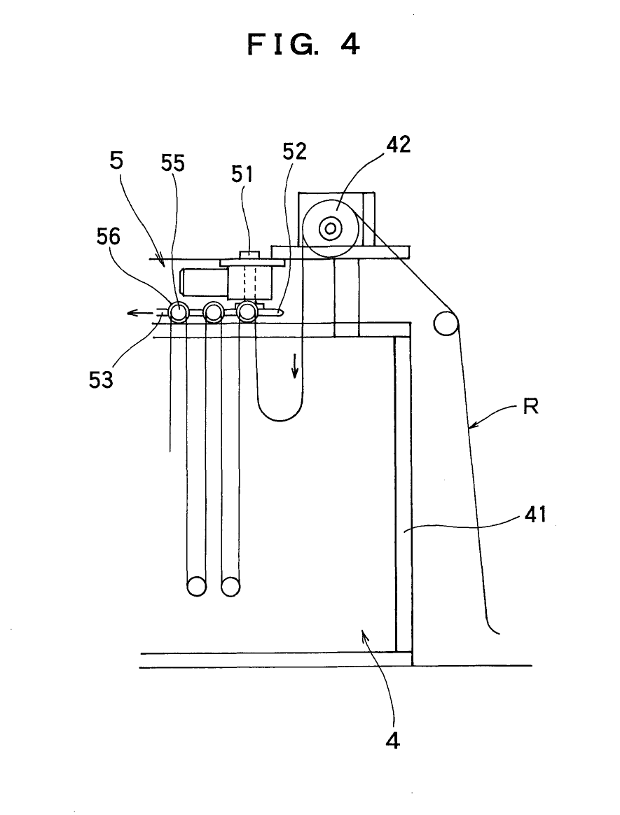

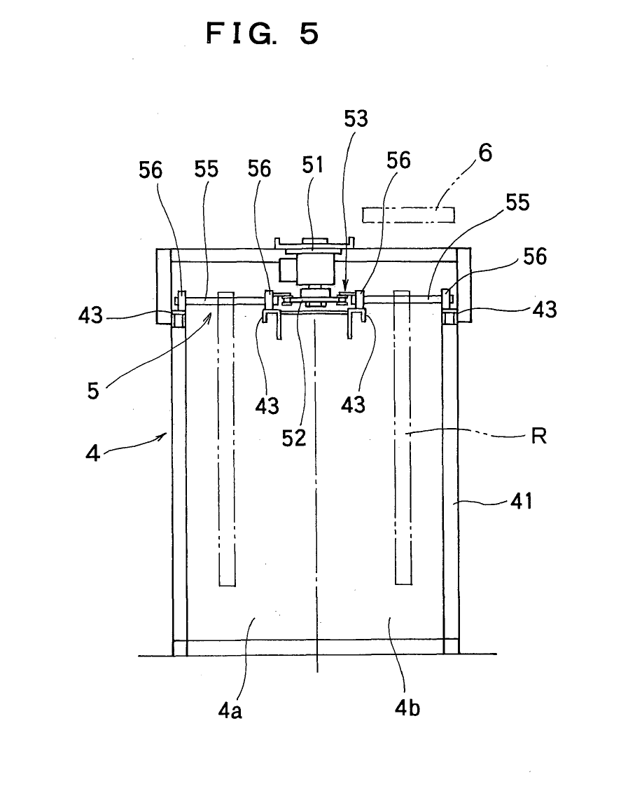

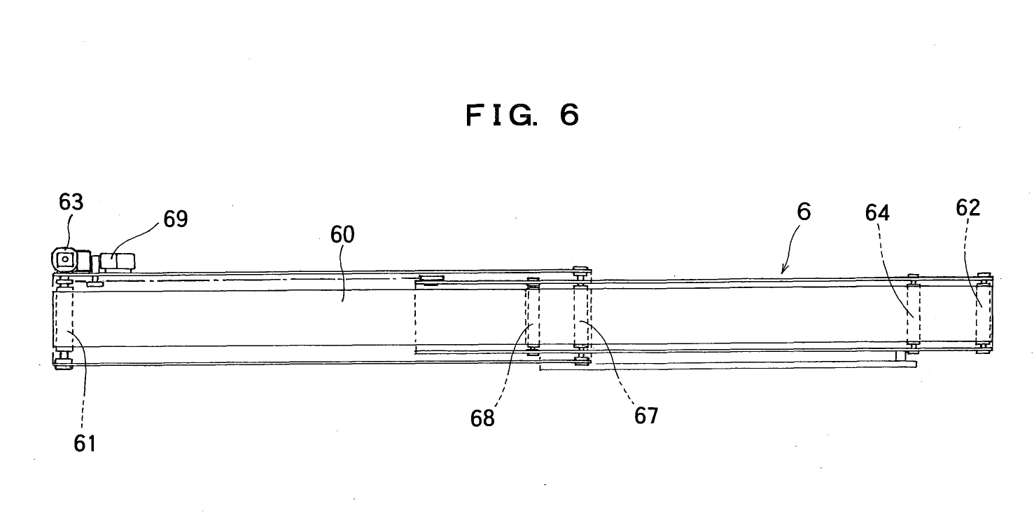

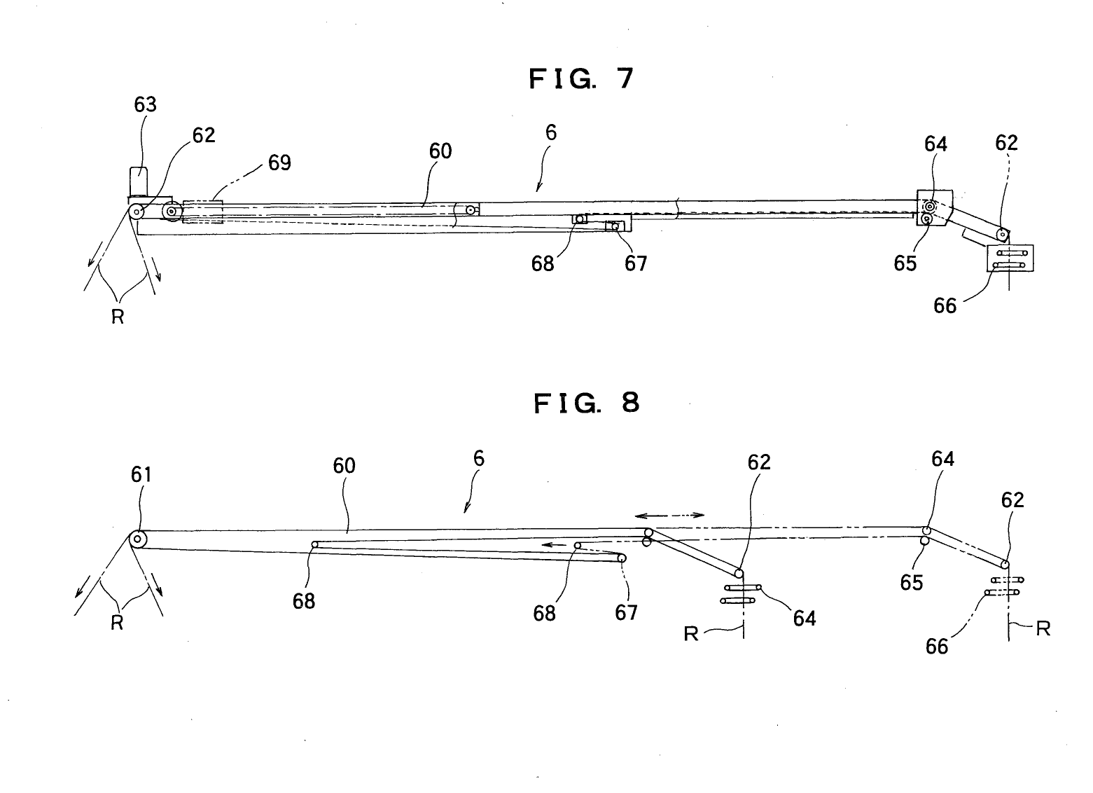

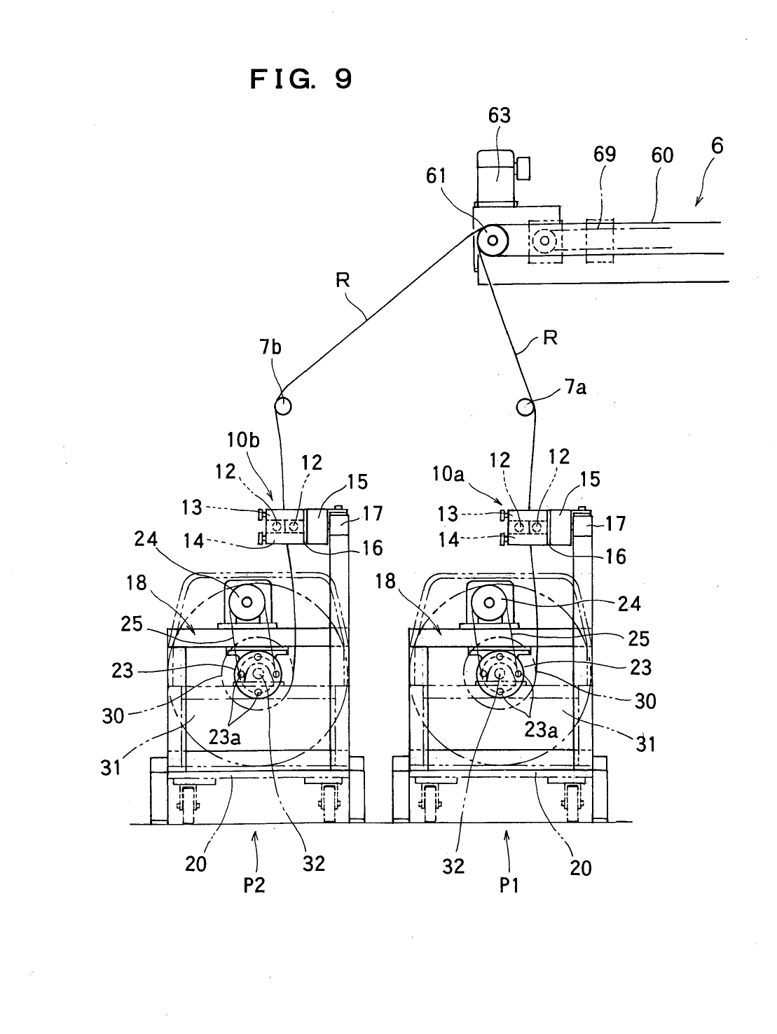

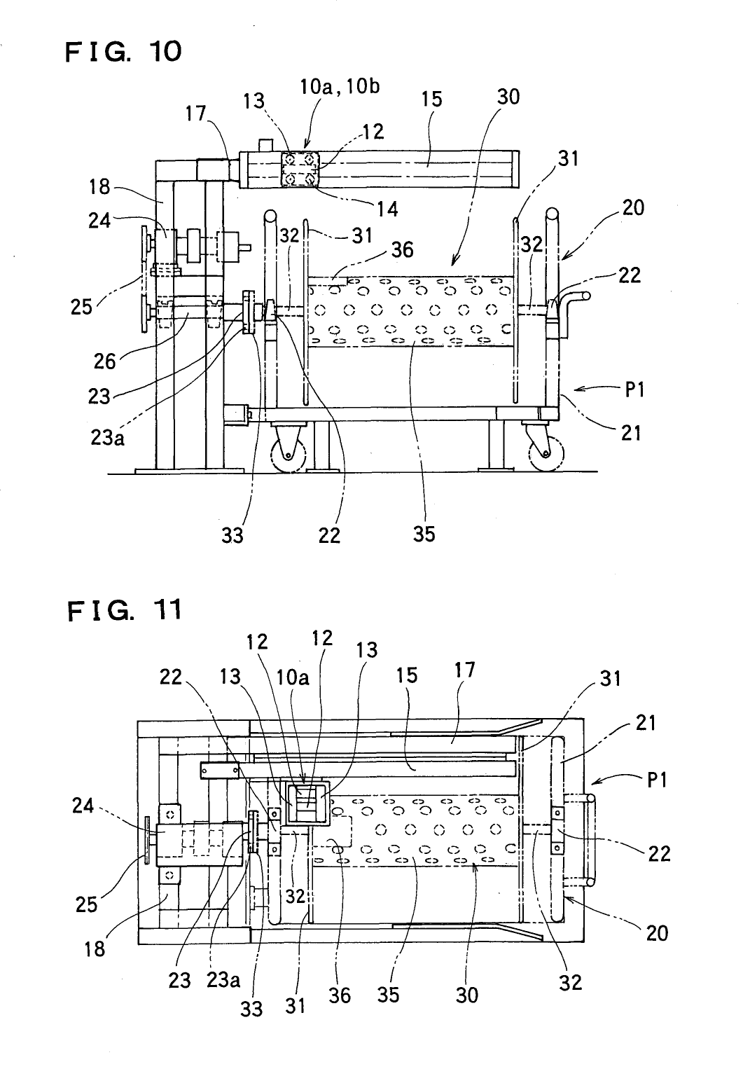

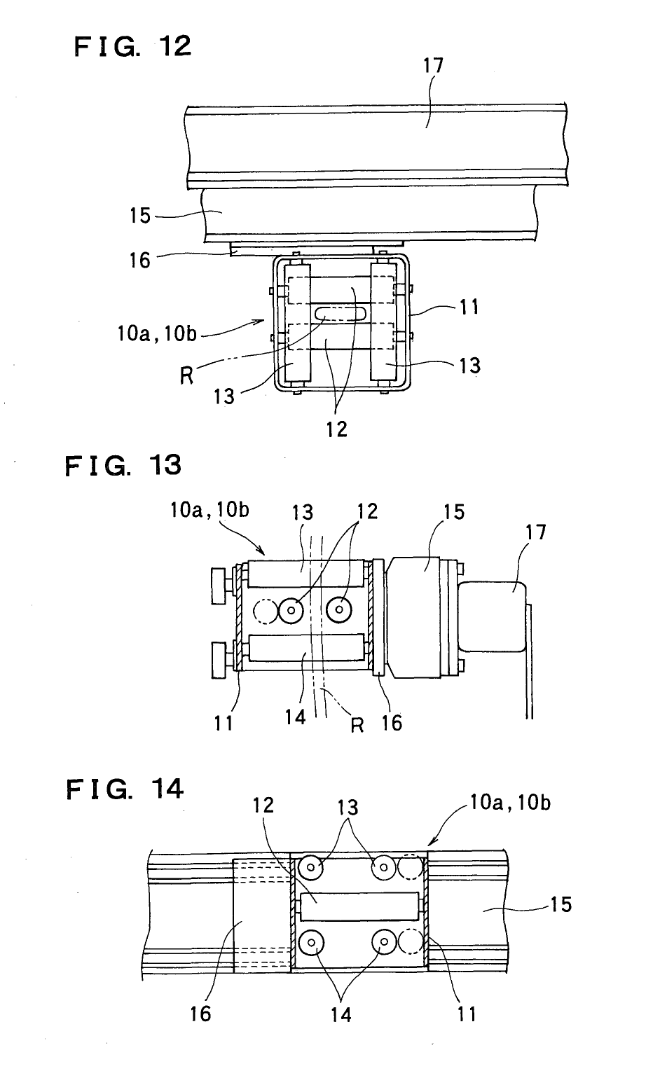

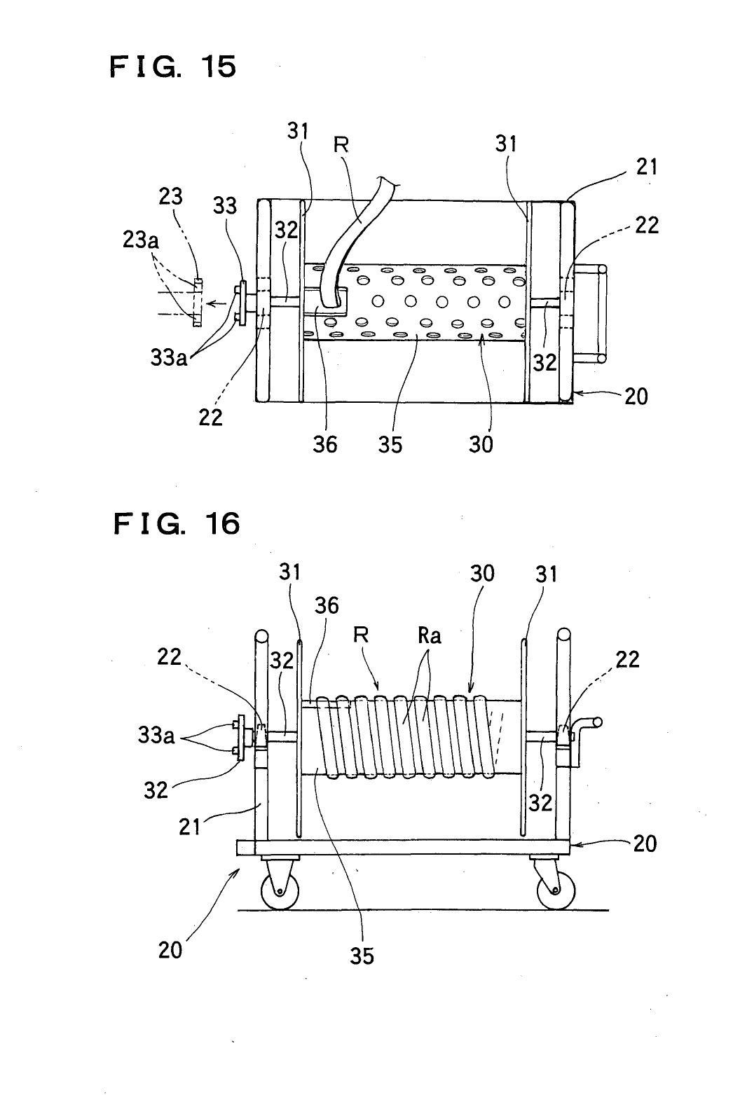

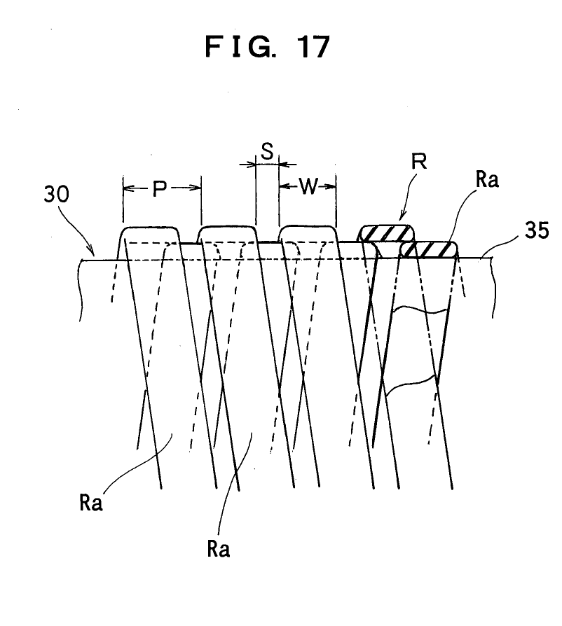

### DESCRIPTION OF REFERENCE NUMERALS AND SIGNS

R: lengthy rubber material, Ra: wound rubber portion of one circumference, w: width dimension, p: pitch, S: spacing, 1: rubber extruder, 2: die, 3: processing vessel, 4: drying apparatus, 4a, 4b: half portion, 5: conveyance means, 6: conveyor device, 7a, 7b: guide bar member, 10a, 10b: traverse guide, 11: support frame, 12, 12: pair of forward and rear rollers, 13, 13: pair of left and right rollers on an upper side, 14, 14: pair of left and right rollers on a lower side, 15: moving means, 16: moving body, 17: transverse frame, 18: body frame, 20: cart, 21: support frame, 23: rotation transmitting portion, 23a: engagement hole, 24: drive means, 25: rotation transmitting mechanism, 26: rotation transmitting shaft, 30: winding roll, 31: flange, 32: spindle, 33: engaging connection, 33a: projection, 35: shell portion, 36: opening, 41: body, 42: feed roller, 43: guide rail, 51: vertical shaft, 52: sprocket, 53: turning member, 55: latch bar, 56: roller, 60: conveyor body, 61, 62: rollers at both ends, 63: drive motor, 64, 65: roller, 66: guide member, 67: intermediate roller, 68: roller for adjustment of movement, 69: drive means for telescopic adjustment, P1, P2: installation

1. A method of winding a lengthy rubber material, wherein a lengthy rubber material continuously extruded in a lengthy manner from a rubber extruder to be fed to a winding position is wound to be made spiral with alternately reverse inclination every layer while being caused by a traverse guide to traverse a winding roll mounted on a moving cart in accordance with rotation of the roll.

2. The method of winding a lengthy rubber material, according to claim 1, wherein the lengthy rubber material has a cross section being a little thick and flat such as rectangular, elliptical, or the like and is wound while being caused to axially traverse at a larger pitch than the width dimension of the lengthy rubber material.

3. The method of winding a lengthy rubber material, according to claim 1 or 2, wherein the rotating speed of the winding roll and that moving speed in an axial direction, at which the lengthy rubber material is caused to traverse, are controlled according to winding of the lengthy rubber material to make the quantity of the rubber material as wound uniform over a total length in a roll axial direction.

4. An apparatus for winding a lengthy rubber material, comprising
a conveyor device that feeds a lengthy rubber material continuously extruded from a rubber extruder,
a traverse guide supported in a position, in which the lengthy rubber material is forwarded from the conveyor device, to be made able to reciprocatively move in a width direction intersecting the forwarding direction and moving while guiding the lengthy rubber material to be capable of forwarding the same,
a moving cart mounted in a predetermined installation below the traverse guide so that it can be pulled out,
a winding roll that is supported on the cart and can be rotationally driven so that an axis thereof is made in parallel to a moving direction of the traverse guide in a state, in which the cart is mounted, and
wherein the traverse guide repeats reciprocating movements in an axial direction of the roll according to rotation of the winding roll to thereby wind the lengthy rubber material while causing the same to traverse in the axial direction of the winding roll.

5. The apparatus for winding a lengthy rubber material, according to claim 4, wherein two forward and rear traverse guides are provided forwardly of a tip end of the feed conveyor device, corresponding installations for the carts are set below the both traverse guides, and winding rolls provided on the carts mounted in the both installations alternately wind the lengthy rubber material.

6. The apparatus for winding a lengthy rubber material, according to claim 4 or 5, wherein the traverse guide comprises a pair of forward and rear rollers arranged widthwise to a direction, in which the lengthy rubber material is forwarded, and a pair of left and right rollers arranged longitudinally at least above or below the rolls, the traverse guide being provided to perform guiding fore and aft and left and right.

7. The apparatus for winding a lengthy rubber material, according to claim 4 or 5, wherein a shell portion of the winding roll on the moving cart is formed by a perforate plate or a meshy body to be drum-shaped, and the drum-shaped shell portion is partially formed with an opening, which enables a wind beginning end of the lengthy rubber material to be inserted thereinto and latched thereon.

8. The apparatus for winding a lengthy rubber material, according to claim 4 or 5, wherein the winding roll is provided at one end thereof with an engaging connection, which engages with a rotation transmitting portion set on a part of a predetermined installation to be capable of transmitting power when the moving cart is mounted on the installation.

9. The apparatus for winding a lengthy rubber material, according to claim 4 or 5, wherein the feed conveyor device is provided to enable a rear end side thereof in a feed direction to make a telescopic adjustment in a longitudinal direction.
